(19) United States
(12) Patent Application Publication
(10) Pub. No.: US 2015/0145485 A1
(43) Pub. Date: May 28, 2015

(54) POWER-FACTOR-CORRECTION (PFC) APPARATUS AND METHOD

(71) Applicant: Intersil Americas LLC, Milpitas, CA (US)

(72) Inventors: Manjing XIE, Fremont, CA (US); Zhixiang LIANG, San Ramon, CA (US)

(21) Appl. No.: 14/614,228

(22) Filed: Feb. 4, 2015

Related U.S. Application Data
(63) Continuation of application No. 13/316,448, filed on Dec. 9, 2011.
(60) Provisional application No. 61/530,886, filed on Sep. 2, 2011.

(51) Int. Cl. H02M 1/42; H02M 1/44

(52) U.S. Cl. CPC H02M 1/4208; H02M 1/44
USPC 323/210; 323/205

(57) ABSTRACT

The various embodiments may include a power supply having a first loop in communication with a power stage of the power supply. A second loop in communication with the first loop may generate a negative reactance value that increases a power factor for the power supply to approximately one. A power supply may also include a rectifier coupleable to an input supply. A power factor compensation circuit coupled to the rectifier may generate a negative reactance. The negative reactance may reduce a phase angle between a current and a voltage provided to the input supply. A method may include sensing an output of a power supply, and adjusting the sensed value. The adjusted value may be compared to a reference value to generate an error value. The error value and a negative reactance value may be combined and the result may be provided to the power supply.

### CLAIM OF PRIORITY

The present application is a Continuation of copending U.S. patent application Ser. No. 13/316,448, filed Dec. 9, 2011; which application claims the benefit of U.S. Provisional Patent Application Ser. No. 61/530,886 filed on Sep. 2, 2011, now expired; all of the foregoing applications are incorporated herein by reference in their entireties.

### TECHNICAL FIELD

Electromagnetic interference (EMI) filters and power-factor-correction (PFC) devices are disclosed. More particularly, EMI reduction filters for PFC devices in switching power converters are disclosed.

### BACKGROUND

The rapid development of power electronics technology has relied, at least in part, on the steadily decreasing size of switching power converters. Unfortunately, the physical size of input filters in higher-power-factor-conversion (PFC) devices has not achieved size reductions in proportion to other portions of the converter assembly. Accordingly, input filters used in PFC devices may account for a large proportion of the weight and physical size in the converter assembly.

### SUMMARY

Electromagnetic-interference (EMI) filters and power-factor-correction (PFC) devices in switching power converters are disclosed. In an aspect, a power supply may include a first loop in communication with a power stage of the power supply. The power supply may also include a second loop in communication with the first loop, where the second loop may be configured to generate a negative reactance that increases a power factor for the power supply, for example, to approximately one. In another aspect, a power supply may include a rectifier coupleable to an input supply. The power supply may also include a power-factor-compensation circuit coupled to the rectifier, where the power-factor-compensation circuit may be configured to generate a negative reactance. The negative reactance may be operable to reduce a phase angle between a current and a voltage provided to the input of the power supply. In still another aspect, a method of power-factor correction in a power supply may include sensing an output signal of the power supply, and adjusting the sensed output signal. The adjusted signal may be compared to a reference signal to generate an error signal. The error signal and a negative-reactance signal may be combined, and the resulting signal may be provided to the power supply.

### BRIEF DESCRIPTION OF THE DRAWINGS

FIG. 1 is a functional block diagram of a stage of a switching power supply.

FIG. 2 is a phasor diagram that further describes the voltage and current relationships of the stage of FIG. 1.

FIG. 3 is a functional block diagram of a stage that may form a part of a switching power supply, according to the various embodiments.

FIG. 4 is a schematic view of an input filter, according to the various embodiments.

FIG. 5 is a phasor diagram that further describes the voltage and current relationships of the stage of FIG. 3, according to the various embodiments.

FIG. 6 is a partial schematic view of a stage that may form a part of a switching power supply, according to the various embodiments.

FIG. 7 is a functional block diagram of a switching power supply and a load powered by the supply, according to the various embodiments.

FIG. 8 is a functional block diagram of a control loop of the switching power supply of FIG. 7, according to the various embodiments.

FIG. 9 is a flowchart that describes a method of adjusting a power factor in a power supply, according to the various embodiments.

FIG. 10 is a schematic diagram of a switching power supply with power-factor correction, and a load that is powered by the supply, according to an embodiment.

### DETAILED DESCRIPTION

In the following description, certain details are set forth in connection with the various embodiments to provide a sufficient understanding. It will be appreciated that the various embodiments may be practiced without these particular details. Furthermore, it will be appreciated that the various embodiments described below do not limit the scope, and that various modifications, equivalents, and combinations of the various embodiments and components of the various embodiments are within the scope presently contemplated. Embodiments that may include fewer than all the disclosed components of any of the various embodiments may also be within the scope although not expressly described in detail. Although the operation of certain well-known components and/or well-known processes may not be shown or described in detail, such omissions may be made to avoid unnecessarily obscuring the various embodiments as they are described.

As a preliminary matter, the reduction of unintentional electromagnetic emissions from electronic devices has received significant regulatory attention in recent years. For example, switching power converters, as well as many other electronic devices, may generate significant amounts of electromagnetic emissions, which may be subject to regulation in the U.S. under the authority granted by Chapter 47 of the Code of Federal Regulations (CFR), Part 15 (Subpart B), or alternatively, under MIL-STD 461C. Outside the U.S., similar regulatory restrictions with respect to electromagnetic emissions from electronic devices using discrete frequencies or repetition rates may be applicable, such as VDE (Verband Deutscher Electrotechniker) 0871, for example. In accordance with the foregoing standards, relatively low electromagnetic-interference (EMI) levels are generally mandated to substantially attenuate switching-power-supply noise. The input-filter design should be configured to achieve relatively low EMI levels and to maintain a relatively small size, while allowing the power supply to achieve a power factor that is approximately unity.

FIG. 1 is a functional block diagram of a stage 10, which may form a part of a switching power supply; for example, the stage may be an input stage of a switching power supply. The stage 10 may include an input filter 12, which may be configured to be coupled to an input supply 14, such as a main supply from the power company to a building. The input filter 12 may include any suitable operational arrangement of elements that may be suitably arranged in various filter designs. For example, the input filter 12 may include any suitable arrangement of resistors, capacitors, inductors, and transformers that may be configured to form a passive filter, such as a Chebyshev filter design, although other suitable filter configurations may also be used. For example, other passive filter designs may include nonlinear elements, or more complex linear elements, such as transmission lines. The input filter 12 may be coupled to a power-factor-correction (or -compensation) (PFC) circuit 16, which may be configured to provide a relatively low phasor angle between an input voltage (e.g., from the input supply 14) and a current supply (e.g., by the input supply 14) to the stage 10. Accordingly, the PFC circuit 16 may provide a phasor angle that is approximately equal to zero, and, therefore, a power factor approximately equal to one.

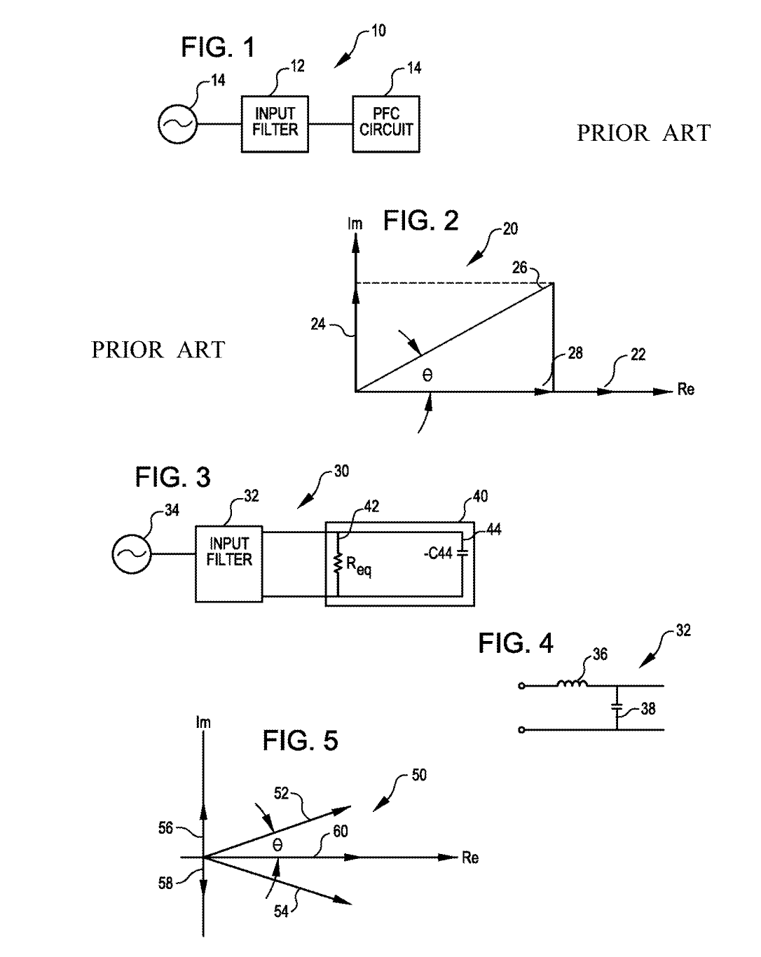

With reference now to FIG. 2, shown is a phasor diagram 20, which may be used to further describe the voltage and current relationships of the stage 10 of FIG. 1. Briefly, the phasor diagram 20 may be used to graphically illustrate the effects of various reactive components, such as inductive and capacitive devices, which may introduce phase differences between the voltage and current applied to the stage 10. A line input voltage 22 (e.g., from the input supply 14 of FIG. 1) may graphically extend along a real axis (Re) in a complex plane. Correspondingly, a reactive component 24 may graphically extend along an imaginary axis in the complex plane. The reactive component 24 may represent capacitive and inductive effects in the input filter 12 (as shown in FIG. 1). Although the reactive component 24 is shown in FIG. 2 as extending along a positive direction on the imaginary axis, it is understood that the reactive component 24 may also extend along a negative direction on the imaginary axis, depending upon the reactive behavior of the input filter 12. Accordingly, a line input current 26 may be displaced from the real axis (Re) by a phasor angle θ, and a voltage input 28 to the PFC circuit 16 (as shown in FIG. 1) may be reduced. An effective PFC circuit 16 may, therefore, reduce a magnitude of the phasor angle θ so that the power transferred to the input stage 10 (of FIG. 1) may be increased.

FIG. 3 is a functional block diagram of a stage 30, such as an input stage, which may form a part of a switching power supply, according to the various embodiments. The stage 30 may include an input filter 32, which may be configured to be coupled to an input supply 34. With reference briefly now also to FIG. 4, the input filter 32 may include an inductor 36 and a capacitor 38 configured in an “L” filter configuration, although other filter configurations may also be used, which may include additional inductive and capacitive components, or even other passive circuit elements. The input filter 32 may be coupled to a PFC circuit 40. In general, an input impedance of the PFC circuit 40 may be resolved into an equivalent resistance (R_{eq}) 42. The equivalent resistance (R_{eq}) 42 may not be sufficient to present a resistive input impedance to the PFC circuit 40 due to the presence of reactive elements in the input filter 32 (e.g., the inductor 36 and the capacitor 38 as shown in FIG. 4). In accordance with the various embodiments, the PFC circuit 40 may be configured to include a negative capacitance (−C) 44 that is electrically in parallel with the equivalent resistance (R_{eq}) 42.

With reference now also to FIG. 5, a phasor diagram 50 is shown, which may be used to further describe the voltage and current relationships of the stage 30 of FIG. 3. As shown therein, a current component 52 corresponding to a current magnitude through the input filter 32 (as shown in FIG. 3) may be graphically offset from the real (Re) axis by a phasor angle θ due to a reactive component 56. A current component 54 into the PFC circuit 40 may also be graphically offset from the real (Re) axis, and may “lag” the current component 52. The introduction of a reactive component 58 by the negative capacitance (−C) 44 (as shown in FIG. 3) may at least partially cancel the reactive component 56 since the reactive component 58 extends oppositely along the imaginary axis of the phasor diagram 50. Accordingly, the resulting input current component 60 may extend substantially along the real axis (Re) of the phasor diagram 50, so that the phasor angle θ may be reduced in magnitude, and the power factor may approach one.

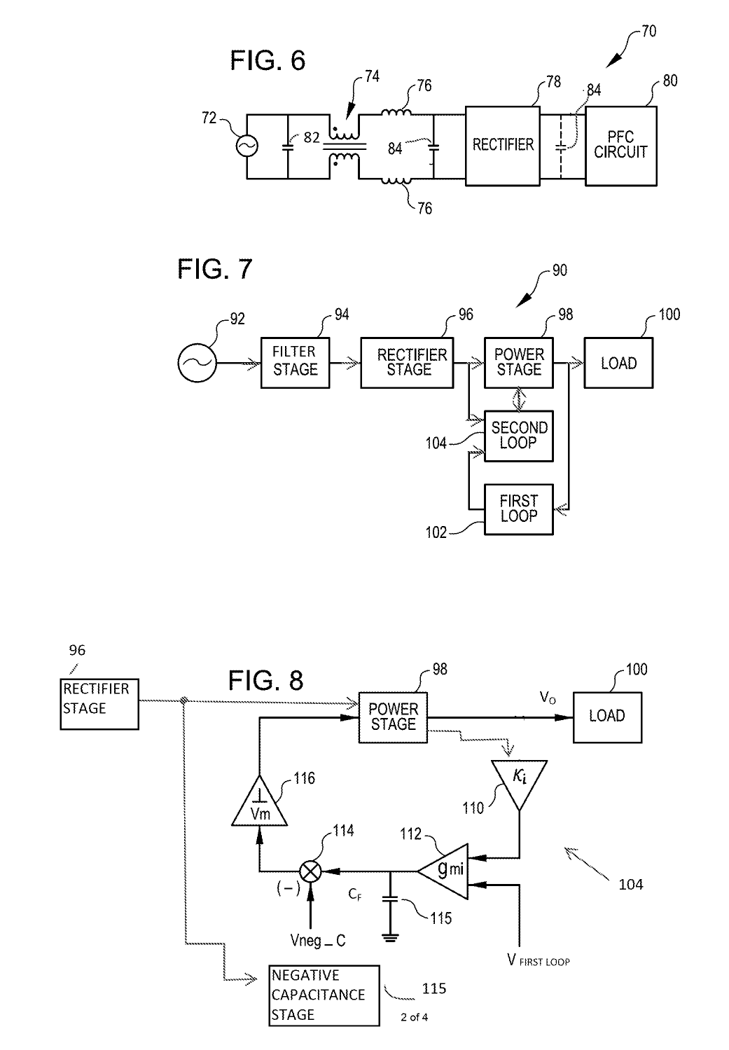

FIG. 6 is a partial schematic view of a stage 70, such as an input stage, which may form a part of a switching power supply, according to the various embodiments. The input stage 70 may be configured to be coupled to an input supply 72, which may include a conventional alternating current (AC) supply source, such as a conventional AC electrical main having a predetermined root-mean-square (RMS) approximately sinusoidal voltage and a predetermined line frequency. The input supply 72 may be coupled to a common-mode transformer 74 having a predetermined turns ratio. Briefly, the common-mode transformer 74 may be configured to reduce common-mode noise that may exist on the relatively long electrical conductors associated with the AC electrical main. The input stage 70 may also include a pair of inductors 76, which may be configured to reduce differential-mode noise that may be associated with the AC electrical main. The input stage 70 may also include a rectifier 78, which may be coupled to the input supply 72, which may be configured to rectify the AC voltage received from the input supply 72, and to convert the AC voltage to a pulsating waveform having a relatively steady DC component. Accordingly, the rectifier 78 may include a half-wave rectification apparatus, or it may include a full-wave rectification apparatus.

The stage 70 may include a PFC circuit 80, which may be configured to generate a negative capacitance, such as the negative capacitance (−C) 44, which was described above. Additional details regarding the generation of the negative capacitance (−C) will be described in further detail below. The stage 70 may also include a first safety capacitor 82 in a first position and a second safety capacitor 84 in a second position. The first safety capacitor 82 and the second safety capacitor 84 may be configured as “X-type” safety capacitors to suppress electrical noise and protect the stage 70 against catastrophic damage that may occur due to electrical surges. The first safety capacitor 82 and the second safety capacitor 84 may also prevent the stage 70 from receiving undesired electromagnetic and radio-frequency interference. Since the first safety capacitor 82 and the second safety capacitor 84 may be coupled between line phases (e.g., across the line, as shown in FIG. 6), the first safety capacitor 82 and the second safety capacitor 84 may effectively reduce symmetrical interference that may occur. Although FIG. 6 shows the first safety capacitor 82 and the second safety capacitor 84 coupled across the line as X-type safety capacitors, it is understood that Y-type safety capacitors that may be coupled between a line phase and a point of zero potential may be present, and may thus be considered within the scope of the present embodiments.

Still referring to FIG. 6, the first safety capacitor 82 and the second safety capacitor 84 may be coupled in various locations within the stage 70. For example, the second safety capacitor 84 may alternatively be coupled to the input stage 70 in a third position (as shown by the broken line representation of the second safety capacitor 84 shown in FIG. 6). The inventors have made the discovery that the movement of the second safety capacitor 84 from the second position to the third position (e.g., from a position before the rectifier 78, to a position following the rectifier 78) may be made feasible by the generation of the negative capacitance (−C) 44 (as shown in FIG. 3) in the PFC circuit 80. Various advantages may accrue from moving the second safety capacitor 84 from the second position to the third position. For example, at least one of the first safety capacitor 82 and the second safety capacitor 84 may be more compact, thus significantly reducing the physical size of the stage 70, and by extension, the size of a switching power supply that incorporates the stage 70. Furthermore, the inventors have made the discovery that positioning the first safety capacitor 82 in the first position and the second safety capacitor 84 in the second position may allow power-factor deterioration to occur under conditions of high input line voltage and light loading conditions on the switching power supply that incorporates the stage 70. Accordingly, positioning the second safety capacitor 84 in the third position, together with generating a negative capacitance within the PFC circuit 80 may permit significant improvements in switching-power-supply operation.

FIG. 7 is a functional block diagram of a switching power supply 90, according to the various embodiments. The switching power supply 90 may be configured to be coupled to an input supply 92, which may include a conventional approximately sinusoidal AC supply source, such as a conventional AC electrical main supply, as described earlier. The switching power supply 90 may also include a filter stage 94, and a rectifier stage 96, which may be configured to convert a symmetrical AC waveform received from the filter stage 94 to a pulsating waveform having a DC component. Accordingly, the rectifier stage 96 may include a half-wave rectification device, or a full-wave rectification device. In either case, the rectifier stage 96 may be coupled to a power stage 98, which may be configured to switch and condition the rectified waveform received from the rectifier stage 96, in addition to performing other operations, such as boosting the voltage from the rectifier stage. The power stage 98 may also be coupled to an electrical load 100.

The switching power supply 90 may also include a first loop 102 and a second loop 104. The first loop 102 may be a voltage-control loop, which may be configured to compare an output voltage to a reference value, and to generate an error signal based upon a difference between the output voltage (or a voltage derived from the output voltage) and the reference value. The first loop 102 may have a relatively narrow bandwidth, which may be, for example, approximately about ten hertz (Hz), although other suitable bandwidth values may be used. The second loop 104 may be a current-control loop that has a bandwidth that may be somewhat larger than the first loop 102. For example, and in accordance with the various embodiments, the second loop 104 may have a bandwidth that may be approximately one-tenth of a frequency F_{SW} at which one or more transistors of the power stage 98 switch. Accordingly, the bandwidth of the second loop 104 may range between approximately two kilohertz (kHz) and approximately 150 kHz, although other bandwidth values may also be suitable. One operational function of the second loop 104 may be to maintain approximately balanced current pulses through an inductive element in the switching power supply 90.

The second loop 104 may be configured to generate the negative capacitance described in connection FIG. 3. Briefly, the negative capacitance may provide appropriate power-factor compensation so that the current drawn from the input supply 92 (as shown in FIG. 3) may be substantially in phase with the voltage provided by the input supply 92.

Referring now to FIG. 8, a functional block diagram of the second control loop 104 in accordance with the various embodiments will now be discussed. With continued reference also to FIG. 7, the second loop 104 may include a current-sense gain stage 110, which is operable to sense a current that flows in the power stage 98, and to apply a gain Kᵢ to the sensed current, where the dimension of Ki may be resistance (i.e., block 110 may be a trans-impedance stage generating an output voltage that is proportional with the sensed current). An output of the current-sense gain stage 110 may be communicated to a current-compensation stage 112, which may be configured to compare the output of the current-sense gain stage 110 to a reference voltage V_{fFIRST}_{_{—}}_{LOOP} from the first loop 102 (FIG. 7). In accordance with the various embodiments, the reference voltage V_{fFIRST}_{_{—}}_{LOOP} may be related to a rectified voltage (e.g., an output of the rectifier stage 96 of FIG. 7) and to an error voltage generated by comparing the output voltage from the power stage 98 with a reference voltage, and gₘᵢ may be a gain value for the current-compensation stage 112. An output from the current-compensation stage 112 may be communicated to a capacitor 115 and to a summer 114, which sums the output from the stage 112 with an output V_{neg}_{_{—}}_{c} from a negative-capacitance-generation stage 115, where V_{neg}_{_{—}}_{c} may be proportional to the rectified voltage (e.g., an output of the rectifier stage 96 of FIG. 7). Accordingly, V_{neg}_{_{—}}_{c} may be expressed as k_{ff}_{_{—}}_{c} multiplied by the rectified voltage, where k_{ff}_{_{—}}_{c} may be a scaling factor. The summer 114 may communicate an output to pulse-width-modulation stage 116, which may have a linearized gain factor of 1/Vₘ, where Vₘ is the amplitude of a PWM ramp signal. The negative capacitance (−C) may be determined based upon the following expression:

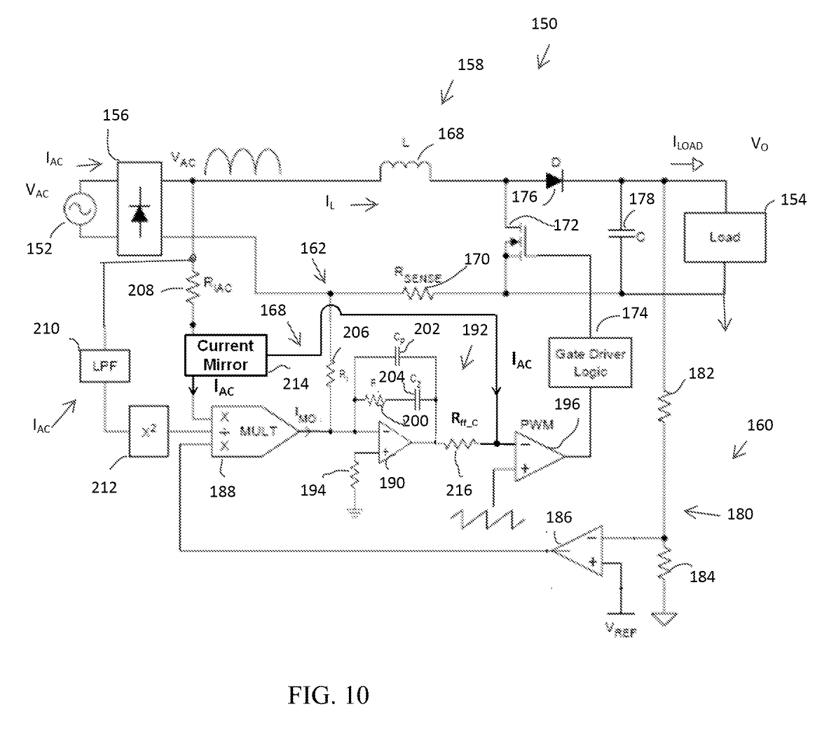

C_{eq}˜[(Vₘ/V₀)−k_{ff}_{_{—}}_{c}]C_{F}/Kᵢgₘᵢ (1)

where C_{F} is the capacitance of the capacitor 115 and V_{O} is the regulated output voltage of the power supply. Accordingly, the capacitance value C_{eq} will assume negative values when the quantity [(Vₘ/V₀)−k_{ff}_{_{—}}_{c}]<1, or (equivalently) when k_{ff}_{_{—}}_{c}>(Vₘ/V₀). The setting of k_{ff}_{_{—}}_{c} is described below in conjunction with FIG. 10 (k_{ffc} is shortened to “k” hereinafter).

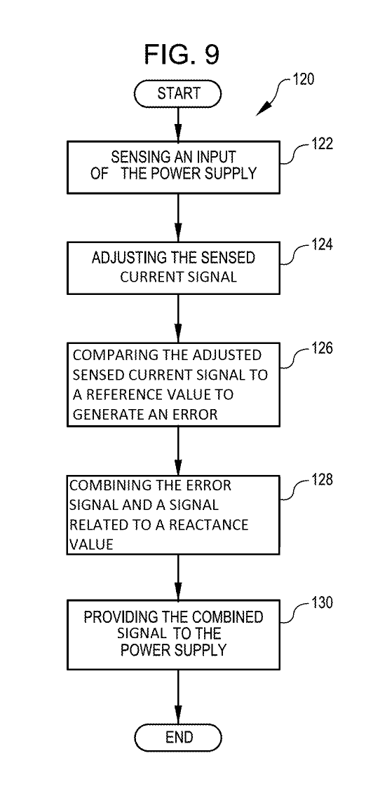

FIG. 9 is a flowchart that will be used to describe a method 120 of adjusting a power factor in a power supply. At step 122, a current of the power supply (power stage) may be sensed. At step 124, the sensed current signal may be adjusted. At step 126, the adjusted sensed current signal from 124 may be compared to a reference signal to determine an error signal based upon a difference between the adjusted sense current signal and the reference signal. At step 128, the error signal may be combined with a signal related to a negative capacitance value. In accordance with the various embodiments, the negative capacitance value may be proportional to a difference between a voltage ratio and a scaling factor, where the difference constitutes the negative capacitance signal. At 130, the combined signal may be provided to the power supply so that a negative capacitance may be generated that offsets reactive effects in an input filter of the power supply.

FIG. 10 is a block diagram of an average-current-mode-controlled boost power supply 150 with power-factor correction PFC, according to an embodiment.

The power supply 150 receives an AC voltage V_{AC} and an AC current I_{AC} from a power source 152, which may be similar to one or more of the power sources 14, 34, 72, and 92 of FIGS. 1, 3, 6, and 7 respectively, and converts VAC into a regulated DC voltage V_{O}. The power supply 150 may provide V_{O} to a load 154 (e.g., a microprocessor, microcontroller, memory, or other integrated circuit), which draws a current I_{Load}.

The power supply 150 includes an input filter (not shown in FIG. 10), a full-wave rectifier stage 156, a power stage 158, a voltage-control feedback loop 160, a current-control feedback loop 162, a scale generator 164, and a negative-capacitance generator 166.

The input filter may be the same as the input filter (capacitors 82 and 84, transformer (choke) 74, inductors 76) of FIG. 6, and the full-wave rectifier stage 156 may be conventional.

The power stage 158 includes an inductor 168 having an inductance L, a sense resistor 170, an N-channel switching transistor 172, a drive circuit 174, a diode 176, and an output filter capacitor 178.

The voltage-control feedback loop 160 includes a voltage divider 180 having resistors 182 and 184, a high-gain differential error amplifier 186, a multiplier 188, a high-gain differential amplifier 190 with a compensation network 192 and a bias resistor 194, and a pulse-width-modulation (PWM) comparator 196. The error amplifier 186 may include a conventional compensation network that is not shown in FIG. 10. The compensation network 192 includes a feedback resistor 200 and two feedback capacitors 202 and 204. And the PWM comparator has an inverting input node coupled to the output node of the amplifier 190, and has a noninverting input node coupled to receive a conventional PWM sawtooth wave having a peak-to-peak voltage amplitude V_{sawtooth}.

The current-control feedback loop 162, which shares some components with the voltage-control feedback loop 160, includes a feedback resistor 206, the differential amplifier 190, the compensation network 192, the bias resistor 194, and the PWM comparator 196

The scale generator 164 includes a resistor 208, a low-pass filter 210, and a squarer 212.

And the negative-capacitance generator 166 includes a current mirror 214 and a resistor 216.

Still referring to FIG. 10, the operation of the power supply 150 is described according to an embodiment.

In general, the power supply 150 generates a regulated output voltage V_{O} while drawing from the power source 152 an input current I_{AC} that has approximately the same wave shape and approximately the same phase as the input voltage V_{AC}. For example, if V_{AC} is a sinusoid, then the power supply 150 draws an approximately sinusoidal input current I_{AC} having approximately the same phase as the V_{AC} sinusoid. By causing I_{AC} to have approximately the same wave shape and phase as V_{AC}, the power supply 150 causes the power source 152 to “see” the power supply as having a power factor of approximately unity, which, as is known, reduces or eliminates power losses in, e.g., the transmission lines between the power source and the power supply, as compared to a power supply having a power factor that is significantly less than unity.

In more detail, the transistor 172 switches at a frequency F_{sw} that is set by the frequency of the sawtooth voltage at the noninverting input of the PWM comparator 196, and switches with a duty cycle that is set by the peak-to-peak amplitude V_{sawtooth} of the sawtooth voltage and the voltage at the inverting node of the PWM comparator (V_{sawtooth} is equivalent to Vₘ of equation (1) and FIG. 8). When the sawtooth voltage is higher than the voltage at the inverting node of the PWM comparator 196, the transistor 172 is “on”; conversely, when the sawtooth voltage is lower than the voltage at the inverting node, the transistor is “off.” Therefore, the lower the voltage at the inverting node, the higher the duty cycle (i.e., the greater the portion of the switching period during which the transistor 172 is on), and the higher the voltage at the inverting node, the lower the duty cycle (i.e., the smaller the portion of the switching period during which the transistor is on).

While the transistor 172 is on, a linearly increasing inductor current I_{L} flows from the rectifier 156, through the inductor 168, the transistor, and the sense resistor 170, back to the rectifier. The slope of the inductor current I_{L} is the instantaneous value of the rectified voltage V_{AC}_{_{—}}_{rectified} divided by the inductance L of the inductor 168. Because the switching frequency (e.g., 2 KHz-500 KHz) is significantly higher than the frequency of V_{AC}_{_{—}}_{rectified} (e.g., 120 Hz), one can assume that for purposes of the below description, the instantaneous value of V_{AC}_{_{—}}_{rectified} is constant during a single switching period.

While the transistor 172 turns off, the inductor current I_{L} linearly decreases from its peak value achieved when the transistor is turned off, and flows from the rectifier 156, through the inductor 168, the diode D, the parallel combination of the capacitor 178 and load 154, and the sense resistor 170, back to the rectifier.

At some time before the transistor 172 turns on again, the inductor current I_{L} goes to a lower, non-zero value (continuous-conduction mode (CCM) or to zero (discontinuous-conduction mode (DCM); in DCM the diode 176 prevents a back current from flowing from the capacitor 178 through the inductor 168. But even in DCM, under heavy-load conditions (e.g., during a step-up load transient), I_{L} may not go to zero such that I_{L} has a value greater than zero throughout the entire switching period.

Disregarding the effects of the current-mode feedback loop 162 and the multiplier 188 for purposes of the immediately following description, the voltage-control feedback loop 160 controls the duty cycle of the transistor 172 such that V_{O} remains at a level approximately equal to

$${V}_{ref} \cdot \frac{{R}_{182} + {R}_{184}}{{R}_{184}} ,$$

where V_{ref} is a stable reference voltage (e.g., from a band gap reference-voltage generator) and R₁₈₂ and R₁₈₄ are the resistance values of the resistors 182 and 184, respectively. If V_{O} is higher than this level, then the voltage-control loop 160 reduces the duty cycle of the transistor 172 so as to reduce V_{O} toward this level; conversely, if V_{O} is lower than this level, then the voltage-control loop increases the duty cycle of the transistor so as to increase V_{O} toward this level. More specifically, if V_{O} is greater than

$${V}_{ref} \cdot \frac{{R}_{182} + {R}_{184}}{{R}_{184}} ,$$

then the output of the error amplifier 186 decreases, thus increasing the voltage level at the inverting input of the PWM comparator 196 so as to decrease the duty cycle of the transistor 172; conversely, if V_{O} is less than

$${V}_{ref} \cdot \frac{{R}_{182} + {R}_{184}}{{R}_{184}} ,$$

then the output of the error amplifier increases, thus decreasing the voltage level at the inverting node of the PWM comparator so as to increase the duty cycle of the transistor. In an embodiment, the bandwidth of the voltage-control feedback loop 160 is relatively low (e.g., about 10 Hz) such that the loop is not designed to respond to load transients (i.e., sudden changes in the load 154), but instead is designed to respond to longer-term load changes, such as in response to the load 154 transitioning into or out of a sleep mode.

Now disregarding the effects of the voltage-control feedback loop 160 and the multiplier 188 for purposes of the immediately following description, the current-mode feedback loop 162 controls the duty cycle of the transistor 172 so that the current I_{L} goes to a lower non-zero value during each switching period if operating in CCM, or to zero during each switching period (except for possibly during a load transient) if operating in DCM. While the transistor 172 is on, the linearly increasing inductor current I_{L} flows through the resistor 170, thus generating a linearly decreasing (increasing in magnitude) negative voltage at the junction between the resistors 170 and 206 (this voltage is negative because the other node of the resistor 170 is coupled to the output ground). Similarly, while the transistor 172 is off, the linearly decreasing inductor current I_{L} flows through the resistor 170, thus generating a linearly increasing (decreasing in magnitude) negative voltage at this junction. The compensation network 192 effectively filters the negative voltage at this junction so as to generate, on the inverting node of the PWM comparator 196, a current-control voltage. If the on time of the transistor 172 increases above a balance point, then the average voltage at the junction of the resistors 170 and 206 decreases, thus increasing the voltage at the inverting input of the PWM 196 and decreasing the transistor on time. Conversely, if the on time of the transistor 172 decreases below the balance point, then the average voltage at the junction of the resistors 170 and 206 increases, thus decreasing the voltage at the inverting input of the PWM 196 and increasing the transistor on time.

Furthermore, in an embodiment, the bandwidth of the current-mode feedback loop 162 is relatively high (e.g., about F_{sw}/10) such that the loop is designed to respond to load transients. For example, if the load current I_{Load} suddenly increases, then this causes a drop in V_{O}, and thus decreases the time it takes the inductor current I_{L} to ramp down during the off time of the transistor 172. This decrease in the rampdown time of I_{L} increases the average voltage at the junction of the resistors 170 and 206, and thus decreases the voltage at the inverting input of the PWM comparator 196 and increases the on time of the transistor 172 to compensate for increase in I_{Load}. Conversely, if I_{Load} suddenly decreases, then this causes an increase in V_{O}, and thus increases the time it takes the inductor current I_{L} to ramp down during the off time of the transistor 172. This increase in the rampdown time of I_{L} decreases the average voltage at the junction of the resistors 170 and 206, and thus increases the voltage at the inverting input of the PWM comparator 196 and decreases the on time of the transistor 172 to compensate for the decrease in I_{Load}.

Still referring to FIG. 10, the scaler 164 adjusts the level of the current into the summing junction at the inverting input of the amplifier 190, and thus adjusts the voltage level at the inverting input of the PWM comparator 196, to account for both the instantaneous amplitude, and the average value, of V_{AC-rectified}.

The scaling resistor 208 converts the rectified voltage V_{AC}_{_{—}}_{rectified} into a current I_{AC}_{_{—}}_{rectified}, which has approximately the same wave shape and the same phase as V_{AC}_{_{—}}_{rectified}.

As described above, to obtain a high power factor at or near unity, the power supply 150 draws from the power source 152 a current I_{AC} that has approximately the same wave shape and phase as V_{AC}. To accomplish this, I_{AC}_{_{—}}_{rectified} effectively scales the on time of the transistor 172 to the amplitude of V_{AC}_{_{—}}_{rectified} such that when V_{AC}_{_{—}}_{rectified} is higher (VAC has a higher magnitude), the on time is longer so that the power supply 150 draws a higher current I_{AC}, and when V_{AC}_{_{—}}_{rectified} is lower (V_{AC} has a lower or zero magnitude), the on time is shorter so that the power supply draws a lower current I_{AC}. That is, I_{AC}_{_{—}}_{rectified} effectively amplitude modulates the on time of the transistor 172 by effectively amplitude modulating the voltage at the inverting input of the PWM comparator 196 with a voltage that is a scaled inverse of V_{AC}_{_{—}}_{rectified}.

And the low-pass filter 210 and the squarer 212 generate V_{AC}_{_{—}}_{rectified}_{_{—}}_{avg}² at a dividing input node of the multiplier 188; that is, the multiplier effectively scales the voltage at the inverting node of the comparator 196 by 1/V_{AC}_{_{—}}_{rectified}_{_{—}}_{avg}². Such scaling adjusts the on time of the transistor 172 to account for different peak amplitudes of V_{AC}_{_{—}}_{rectified}, and thus to account for different peak amplitudes of V_{AC}. The inductor current I_{L} depends on the instantaneous amplitude of V_{AC} and V_{AC}_{_{—}}_{rectified}. So, for a given transistor on time, I_{L} is greater for a higher amplitude of V_{AC} and is lower for a lower amplitude of V_{AC}. If the peak amplitude of V_{AC} changes over time (e.g., summer brownout) or from use to use (e.g., in Europe versus in the U.S.), then scaling the on time of the transistor 172 by V_{AC}_{_{—}}_{rectified}_{_{—}}_{avg}² prevents the duty cycle of the transistor 172 from becoming too long or too short. For example, V_{AC} may range anywhere from 85 V_{RMS} to 120 V_{RMS} in the U.S. depending on conditions such as the total load on the power source 152, whether a brownout is occurring due to heavy usage, etc. But in China or in other countries, V_{AC} may range from 165 V_{RMS} to 265 V_{RMS} depending on conditions.

In summary, the voltage-control feedback loop 160 maintains V_{O} at a relatively constant level by compensating for long-term trends in the load 154 (e.g., transitioning to or from a sleep mode), the current-mode feedback loop 160 causes I_{L} to ramp down to a lower value (CCM) or to go to zero (DCM) during each switching period and compensates for short-term (transient) changes in the load (e.g., during the transition period to or from a sleep mode), and the scaler 164 modulates the duty cycle of the transistor 172 with a scaled version of V_{AC}_{_{—}}_{rectified} (implements power-factor correction) and scales the duty cycle according to the peak amplitude of V_{AC}_{_{—}}_{rectified} (compensates for dynamic changes in V_{AC} and for use in different countries or with power systems).

Still referring to FIG. 10, as described so far, the power supply 150 operates as a boost power supply with power-factor correction that may be corrupted by the current drawn by the input-filter capacitors (e.g., the capacitors 82 and 84 of FIG. 6), this current being out of phase (i.e., by about 90°) with V_{AC}.

But the negative-capacitance generator 166 effectively compensates for this out-of-phase current by causing the power supply 150 to generate a compensation current having approximately the same amplitude as the out-of-phase current and a phase that is approximately 180° different than the phase of the out-of-phase current. That is, the compensation current effectively provides the out-of-phase current to the input filter capacitor(s) so that the input current I_{AC} is substantially uncorrupted; that is, ideally, the out-of-phase component of I_{AC} generated by the input filter capacitor(s) appears to be approximately zero. An example of such an out-of-phase current 52 and of such a compensation current 54 is described above in conjunction with FIG. 5. One may view the out-of-phase current and compensation current as having opposite phases in the sense that the input filter capacitor(s) sink the out-of-phase current from a node while the generator 166 causes the feedback circuitry of FIG. 10 to source to the same node a current of approximately equal magnitude and phase to the input filter capacitor(s). Because one current is into the node and the other is out from the node (opposite directions), the currents are said to be approximately 180° out of phase with one another.

The negative-capacitance generator 166 generates a negative capacitance C_{neg} by injecting a current V_{AC}_{_{—}}_{rectified}/R₂₀₈ (via the current mirror 214 with a 1:1 mirroring ratio) into the resistor 216, where C_{neg} is given by the following expression:

$${C}_{neg} = \frac{\frac{{V}_{sawtooth}}{{V}_{O}} - k}{K \cdot {g}_{m}} \cdot ( {C}_{202} + {C}_{204} ) , k > \frac{{V}_{sawtooth}}{{V}_{O}} \qquad ( 2 )$$

where V_{sawtooth} is the peak-to-peak amplitude of the sawtooth wave at the noninverting input of the comparator 196, V_{O} is the output voltage of the power supply 150, k=R₂₁₆/R₂₀₈,

$$K = \frac{{R}_{206}}{{R}_{206} + {R}_{170}} ,$$

gₘ is the gain of the circuit formed by the amplifier 190 and compensation network 192, and C₂₀₂ and C₂₀₄ are the capacitances of the capacitors 202 and 204, respectively. This expression can be derived from the equation for the reactive-current component of the loop gain I_{L}/V_{AC-rectified} of the current-control loop 160, where this latter expression ignores the input to the multiplier 188 from the error amplifier 186. Described in another manner, the amplifier 190 and compensation network 192 impart a phase to the voltage component generated by the current V_{AC}_{_{—}}_{rectified}/R₂₀₈ injected into the resistor 216 such that this voltage component is approximately in phase with the current drawn by the input filter capacitor(s) such that the transistor 172 effectively provides a negative current back through the inductor 168 to compensate for the current drawn by the input filter capacitor(s).

Still referring to FIG. 10, an embodiment of a procedure for designing the power supply 150 is described.

First, a designer selects the size of the common-mode choke 74 (FIG. 6) that he/she wants to use in the filter stage 94 (FIG. 7).

Next, the designer determines the values of the capacitors 82 and 84 that provide the filter stage 94 (FIG. 7) with the desired level of differential-mode filtering. As described above, there can be one or two capacitors 84; if there is only one capacitor 84, then it may be located either on the input side or on the output side of the rectifier 156.

Then, the designer calculates the magnitude of C_{neg} according to the following expression:

C₈₂+C₈₄≧|C_{neg}|≧C₈₄′ (3)

where C₈₄′ is the capacitance of a capacitor 84 on the output side of the rectifier 156 if such a capacitor is included in the power supply 150. If there is no capacitor on the output side of the rectifier 156, then expression (3) reduces to:

C₈₂+C₈₄≧C_{neg}. (4)

Still referring to FIG. 10, alternate embodiments of the power supply 150 are contemplated. For example, the current mirror 214 may have a mirror ratio other than 1:1.

It is understood that even though various embodiments and numerous details of the various embodiments have been set forth in the foregoing disclosure, it is to be regarded as illustrative only, and various changes may be made, and yet remain within the broad principles of the various embodiments. For example, certain of the components described above may be implemented using either digital or analog circuitry, or a combination of both, and also, where appropriate, may be realized in part, or even wholly through software configured to be executed on suitable processing devices. It should also be noted that various functions performed by the components in the various embodiments may be combined to be embodied in fewer elements or separated and performed by more elements. Therefore, the various embodiments may be limited only by the appended claims. Moreover, although embodiments of sigma-delta analog-to-digital converters have been disclosed, various attributes associated with the various embodiments may be applicable to digital-to-analog sigma-delta converters as well and to the extent such principles are applicable to such digital-to-analog converters these converters are within the scope of the various embodiments.

1.-20. (canceled)

21. A power-supply controller, comprising:
a generator configured to generate a signal in response to an input voltage that has a first phase and that causes a current having a second phase to flow through a reactive component of a power supply that generates an output voltage in response to the input voltage, the second phase being different from the first phase; and
a circuit configured to correct a power factor of the power supply by compensating for the current in response to the signal.

22. The power-supply controller of claim 21, wherein the generator is configured to generate as the signal a current that has approximately the first phase.

23. The power-supply controller of claim 21 wherein the generator includes a current mirror that is configured to generate as the signal a current that has approximately the first phase.

24. The power-supply controller of claim 21 wherein the circuit includes a feedback circuit.

25. The power-supply controller of claim 21 wherein the circuit is configured to compensate for the current by effectively supplying a compensation current that has approximately a same magnitude and an opposite phase as the current.

26. The power-supply controller of claim 21 wherein the circuit is configured to compensate for the current by controlling a duty cycle of a switching transistor of the power supply in response to the signal.

27. A power supply, comprising:
an input node configured to receive an input voltage;
an output node configured to provide a regulated output voltage;
an inductor coupled to the input node;
a reactive component coupled to the input node and configured to draw, in response to the input voltage, a reactive current that is out of phase with the input voltage;
a switching component configured to draw an energizing current through the inductor during a first time and to allow a de-energizing current to flow from the inductor to the output node during a second time; and
a control circuit configured to control, in response to the input voltage, the switching component to provide a compensation current having approximately the same amplitude as, and approximately an opposite phase to, the reactive current.

28. The power supply of claim 27 wherein the reactive component includes a capacitor.

29. The power supply of claim 27 wherein the switching component includes a transistor.

30. The power supply of claim 27 wherein the control circuit is configured to cause the switching component to source the compensation current by controlling a length of the first time.

31. The power supply of claim 27 wherein the control circuit is configured to cause the switching component to provide the compensation current by lengthening the first time in response to a decrease in a magnitude of the reactive current.

32. The power supply of claim 27 wherein the control circuit is configured to cause the switching component to provide the compensation current by shortening the first time in response to an increase in the magnitude of the reactive current.

33. The power supply of claim 27 wherein the control circuit is configured to regulated the regulated output voltage by controlling at least one of the first and second times.

34. The power supply of claim 27 wherein the control circuit is configured:
to control the switching component with a control voltage, and
to generate a component of the control voltage having a different phase than the input voltage.

35. The power supply of claim 27 wherein the reactive component is configured to draw the reactive current from the input node.

36. The power supply of claim 27 wherein the control circuit configured to control the switching component to provide the compensation current to the input node.

37. A method, comprising:
generating a regulated output voltage in response to an input voltage;
generating into a node and in response to the input voltage a reactive current that is out of phase with the input voltage; and
generating into the node a compensation current having approximately the same amplitude as, and approximately an opposite phase to, the reactive current.

38. The method of claim 37 wherein generating the regulated output voltage includes generating the regulated output voltage having a magnitude that is greater than a magnitude of the input voltage.

39. The method of claim 37 wherein generating the compensation current into the node causes a phase of an input current to be approximately the same as a phase of the input voltage.

40. The method of claim 37 wherein generating the reactive current includes generating the reactive current in response to one or more capacitances.

41. The method of claim 37 wherein generating the compensation current includes generating the compensation current in response to the input voltage.

42. The method of claim 37, further comprising:
switching a device;
wherein generating the regulated output voltage includes generating the regulated output voltage by controlling a duty cycle of the device in response to a reference and the regulated output voltage; and
wherein generating the compensation current includes generating the compensation current by controlling the duty cycle of the device in response to the input voltage.

43. A non-transitory computer-readable medium storing instructions that, when executed by a computing apparatus, cause the computing apparatus, or a circuit under the control of the computing apparatus:
to generate a regulated output voltage in response to an input voltage;
to generate into a node and in response to the input voltage a reactive current that is out of phase with the input voltage; and
to generate into the node a compensation current having approximately the same amplitude as, and approximately an opposite phase to, the reactive current.
